(19) United States
(12) Patent Application Publication
(10) Pub. No.: US 2024/0130029 A1
(43) Pub. Date: Apr. 18, 2024

(54) EDGE CURRENT DRIVE IN MAGNETIC FUSION DEVICES

(71) Applicants: Michael T. Kotschenruether, Austin, TX (US); Swadesh M. Mahajan, Austin, TX (US); David R. Hatch, Austin, TX (US)

(72) Inventors: Michael T. Kotschenruether, Austin, TX (US); Swadesh M. Mahajan, Austin, TX (US); David R. Hatch, Austin, TX (US)

(73) Assignee: Fusion Energy Associates LLC, Austin, TX (US)

(21) Appl. No.: 18/379,625

(22) Filed: Oct. 12, 2023

Related U.S. Application Data
(60) Provisional application No. 63/415,611, filed on Oct. 12, 2022.

(51) Int. Cl. H05H 1/14; H05H 1/46

(52) U.S. Cl. CPC H05H 1/14; H05H 1/4652

(57) ABSTRACT

A toroidally confined plasma vessel defines a magnetically confined (MC) plasma region that is substantially symmetric by rotation around a central axis and where particles traveling along magnetic fields substantially never strike a wall. A plurality of magnetic field coils provides at least one X-point and guides plasma particles from the magnetically confined plasma region to the divertor target. A total magnetic field strength (comprising all components of the magnetic field) at the divertor target differs substantially from a total magnetic field strength (comprising all components of the magnetic field) at a position of the X-point on a last closed flux surface nearest to it; and a current drive means is operative in the MC plasma, including in the region near the Last Closed Flux Surface.

### CROSS-REFERENCE TO RELATED APPLICATIONS

This application claims priority to provisional application Ser. No. 63/415,611, titled “An FPP based upon a toroidal pinch, as the core of an electrical power plant,” filed on Oct. 12, 2022, provisional application, which is incorporated herein in its entirety by reference.

### FIELD OF INVENTION

This invention generally relates to magnetically confined plasmas for producing nuclear fusion reactions.

### BACKGROUND OF THE INVENTION

Magnetically Confined (MC) plasmas must maintain temperatures on the order of 100 million degrees to create substantial fusion energy. This is about 10 kilo-electron Volts (keV) in units for temperature used within the art. Such temperatures are necessary to produce intense thermonuclear fusion reactions. This is needed for fusion to be a useful energy source, for which, the fusion energy produced must be many times greater than the energy that is input to the MC plasma. The ratio of the energy produced to the energy input is called the fusion gain, and this must be considerably greater than one. (This quotient is usually denoted by Q.)

In the large majority of MC concepts, the magnetic configuration is known as “toroidal”, that is, the magnetic fields form a torus-shaped region where extremely hot plasma is confined. For example, three devices are being constructed to show energy gain soon, and all of them have such a toroidal magnetic configuration: ITER (an international effort by governments), SPARC (by the private company Commonwealth Fusion Systems), and Polaris (by the private company Helion). More generally, examples of toroidal plasma configurations considered for producing fusion energy include, but are not limited to, tokamaks, spherical tokamaks, stellarators, toroidal pinches, Reversed Field Pinches, Field Reversed Configurations (FRCs), and spheromaks.

As is well known in the art, fusion energy gain is strongly dependent upon what is called the energy confinement time—typically the time in which the MC plasma will lose its high-temperature state. A high energy-confinement time is essential for a fusion device. And even for fusion devices where energy gain is not the main goal, for example, where fusion neutrons are used for transmutation, high confinement makes the device much less expensive to run (by reducing expensive energy inputs).

Many consider the toroidal MC concept to be the leading concept to achieve energy gain greater than one. Attaining energy gain is not easy: after decades of effort and billions of dollars of expenditures in many different countries, the energy confinement is still somewhat too small for energy gain, even for the most advanced versions of the MC concept.

Many devices have high cost to achieve energy gain from fusion. A primary reason for this is that the strong magnetic field of MC devices is very expensive to produce. By increasing the magnetic field, one can increase the amount of plasma in the device, and thus increase the amount of fusion energy a device can produce. But this is expensive, because creating magnetic fields is very expensive. Clearly, one would rather increase the amount of plasma one can put in the device without increasing magnetic field, and within the art, there are ways that are known to do this.

The limitation on the amount of plasma that one can add to a toroidal magnetic configuration is usually established by the onset of instabilities known as Magneto-Hydro-Dynamic (MHD) instabilities. It is known in the art that one can often reduce or cure these instabilities by an appropriate driving current in the plasma. This would allow more hot plasma to be confined in the magnetic field.

But unfortunately, driving current in steady state is also expensive. Driving current by using inductive electric fields can be much less expensive, but this is inevitably transient, and transient operation of a fusion device introduces serious engineering problems.

Magnetohydrodynamic instabilities called Edge Localized Modes (ELMs) arise in tokamaks and spherical tokamaks operating in the so-called H-mode. The H-mode is commonly used to attain fusion gain in this class of devices. These ELMs pose another serious problem to tokamaks and spherical tokamaks. As their name suggests, these instabilities are located at the edge of the plasma, and they cause the rapid expulsion of energy that impacts the walls of the device, causing intolerably intense heat fluxes. For example, ITER and SPARC are both tokamaks that operate in H-mode, and ELMs are acknowledged to be a serious concern for both devices for the reasons just stated. It is known in the art that driving current in the edge regions can be stabilizing to such instabilities and can be used to reduce or eliminate ELMs. (This is described in “Effective current drive in the pedestal region of high-confinement tokamak plasma using electron cyclotron waves”, C. Y. Li et al 2022 Nucl. Fusion 62 096027 and “Radio-frequency current drive for thermonuclear fusion reactors”, A. Cardinali Nature Scientific Reports volume 8, Article number: 10318 (2018))

A toroidal pinch also can have major benefits from currents driven in the edge region. First, we delineate the difference between a tokamak and a toroidal pinch. It is in a parameter that is well known in the field, called the rotational transform. (This is the reciprocal of another well-known parameter, the safety factor q). Pinches have a rotational transform greater than one, whereas tokamaks have a rotational transform less than one. Furthermore, to distinguish a pinch from certain stellarators, the predominant source of the rotational transform in a toroidal pinch is the current in the plasma. Some embodiments of pinches are nearly symmetric around an axis of revolution, but other embodiments may have significant non symmetry.

Driving a current near the edge of a toroidal pinch stabilizes a different class of MHD modes. Toroidal pinches, such as the Reversed Field Pinch (RFP), have a type of MHD mode known in the art as a tearing mode. These tearing mode instabilities lead to large losses of energy that seriously degrade confinement. This degradation from these instabilities is so severe that it is widely suspected that toroidal pinches are not capable of energy gain from fusion. This is highly unfortunate, since toroidal pinches contain plasma with much lower magnetic fields than tokamaks, and hence are much less expensive. A device to achieve energy gain that is considerably less expensive than a tokamak would be very attractive. But because the tearing modes are so damaging to confinement, there are no known plans (by any government or any start-up) for a fusion device to show energy gain from an RFP, whereas there are several tokamaks that are being constructed to show this relatively soon (e.g., SPARC and ITER). In the case of the RFP, it is known that driving a current in the edge stabilizes these tearing modes. (See “Magnetohydrodynamic effects of current profile control in reversed field pinches”, C. R. Sovinec and S. C. Prager 1999 Nucl. Fusion 39 777 and “High confinement plasmas in the Madison Symmetric Torus reversed-field pinch”, B. E. Chapman et. al. Phys. Plasmas 9, 2061-2068 (2002)). This has been demonstrated transiently in experiments, and while the tearing modes are stabilized, the energy confinement is comparable to or better than tokamaks. So, this is another example where driving a current in the edge to stabilize MHD modes would be very beneficial.

The importance of this fact can be gauged by the fact that presently, there is no proposal for a toroidal pinch like an RFP to achieve fusion energy gain, because their energy confinement is usually much less than a tokamak. However, tokamaks are being built to show fusion gain, even though they are much more expensive than an RFP. So, a practical means of enabling a toroidal pinch like an RFP to have confinement comparable to a tokamak is obviously of major value.

Despite all the benefits mentioned above, there is a major impediment to driving current in the edge. This applies to toroidal pinches, tokamaks, and other toroidal magnetic configurations that confine plasma. Within the art, it is well known that it is especially expensive to drive current near the edge of the plasma. This is because the edge of the plasma is relatively colder than the core of the plasma, and it requires considerably more energy input to the plasma to drive current in a colder plasma. Within the art, the ratio of the current produced to the power needed is called the efficiency. So, in these terms, at the edge, there is a low CD efficiency. Since it requires so much energy to drive the current, it becomes far more difficult to reach fusion gain, since the fusion energy released must be commensurately greater than such energy inputs to the plasma. It also requires equipment with a higher capital cost, because a much higher wattage of CD power is needed, and this translates directly to higher equipment cost.

These serious problems are all a consequence of low CD efficiency. Accordingly, solutions are sought to greatly increase CD efficiency at the edge.

There is another aspect of the prior art that will turn out to be relevant to the invention. Many toroidal confinement devices include an aspect that is well known in the field, called a poloidal divertor. We will call such divertors simply a divertor. This aspect is considered to be important for exhausting the power and particles of the MC plasma. This aspect is generally considered to have no bearing upon driving current in the plasma. To one of normal skill in the prior art, the design of the divertor is not thought to provide any significant advantage to the CD efficiency of the MC plasma.

In summary, in the prior art, it is very difficult to drive current in the edge of a plasma whose objective is to reach fusion gain at low cost. This is because of the low CD efficiency at the edge. This impediment is significant for various types of toroidal magnetic configurations including, but not limited to, toroidal pinches, tokamaks, spherical tokamaks, and spheromaks. Furthermore, in the prior art, the divertor is not thought to be able to materially improve this situation.

### SUMMARY OF THE PRIOR ART

Many methods of steady-state Current Drive (CD) are known in the prior art. These include, but are not limited to, neutral beam injection, inductive current drive, and the injection of Radio Frequency (RF) waves including Lower Hybrid Current Drive (LHCD), Electron Cyclotron Current Drive (ECCD), Fast Wave Current Drive (FWCD), High Harmonic Fast Wave (HHFW) Current Drive, Helicon wave Current Drive (HCD), and current drive from other oscillating electromagnetic fields such as rotating magnetic field Current Drive, and Imposed Dynamo Current Drive (IDCD).

Inductive current drive, which is transient, is widely used in many toroidal confinement devices. It drives current throughout the plasma, and therefore also drives it in the edge.

An additional method of current drive arises in some plasmas, especially toroidal pinches, and is due to plasma generated fluctuating electromagnetic fields.

Various means have been proposed to improve current drive efficiency in the edge. For example, for methods using RF waves, changing the spectrum or character of the wave can improve this. (For example, see the papers mentioned above, “C. Y. Li et al 2022 Nucl. Fusion 62 096027 and A. Cardinali Nature Scientific Reports volume 8, Article number: 10318 (2018)).

There is another way to improve current drive efficiency—all of the CD methods listed above share something in common: the current is driven against the tendency of Coulomb collisions to dampen the current. This collisional damping is reduced by increasing electron temperature, and also in many cases, by reducing the electron density. So, in all the cases listed above, the current drive efficiency increases with increasing electron temperature. And, in every case above, except Ohmic current drive and possibly IDCD and rotating magnetic field current drive, the current dive efficiency increases with decreasing plasma density.

### SUMMARY OF THE INVENTION

The invention described here increases current drive efficiency by increasing the temperature in the region of the edge, and also reducing the density there. So, this applies to all the current drive methods mentioned explicitly above, as well as others. It achieves improved current drive efficiency in a way that is powerful and general. It applies to all toroidal magnetic configurations, including, but not limited to, toroidal pinches, tokamak, spherical tokamaks and spheromaks. And it also applies to such cases mentioned above where current drive efficiency in the edge has already been improved by changing the spectrum or character of the waves in RF CD, and thereby increases the efficiency even more.

In the prior art, it is quite difficult to increase the edge temperature or reduce the edge density, for MC plasmas of the scale and power where fusion gain is significant. The present invention solves problems in the prior art to allow this method of increasing current drive efficiency.

Specifically, we describe a way to achieve a plasma edge with low density and high temperature without degrading the plasma, and without reducing its CD efficiency due to impurities, and without damaging the walls of the device. Impurities increase the collisional damping of current efficiency and reduce the CD efficiency.

According to some embodiments, a toroidally confined plasma vessel defines a magnetically confined (MC) plasma region that is substantially symmetric by rotation around a central axis and where particles traveling along magnetic fields substantially never strike a wall. A plurality of magnetic field coils provides at least one X-point and guides plasma particles from the magnetically confined plasma region to the divertor target. A total magnetic field strength (comprising all components of the magnetic field) at the divertor target differs substantially from a total magnetic field strength (comprising all components of the magnetic field) at a position of the X-point on a last closed flux surface nearest to it; and a current drive means is operative in the MC plasma, including in the region near the Last Closed Flux Surface. The mean free path of the neutrals is longer than the width of the SOL.

To appreciate the novelty of this, we first describe the problems that arise in the prior with an edge that has high temperature and low density.

Devices that use toroidal MC plasmas employ the following principle, which is well known in the art. Strong magnetic fields guide high-temperature particles so that they travel round and round in a toroidal region without ever hitting a material wall. This prevents the plasma from quickly losing energy to the wall. It also prevents the wall from being destroyed by the thermonuclear plasma, which must be far hotter than any material can tolerate for an extended period.

Let us focus our attention on this region near the edge. A representative geometry of the previous art, including the positions of the terminology used here, is shown in FIG. 1. As is well known in the art, the MC region 101 has a limited extent. By this, we mean that the region where the particles go round and round without hitting a wall has a limited extent. Within the art, the boundary of this region is called the “Last Closed Flux Surface”, or LCFS 102. Outside of the LCFS, the magnetic fields guide a particle to intersect with a wall in a fairly short distance. This is extremely different from the region inside. Introducing another term from the art: the plasma in the region outside the LCFS is called the Scrape Off Layer (SOL). In FIG. 1 the SOL is bounded between the LCFS 102 and other surfaces 103. And here is another term as well: the region near where the plasma that interacts with the wall is called the divertor. And another term is that the plasma strikes the material wall at a location called the strike point 104 and 140 of the divertor target 105 and 150.

The plasma edge is near to the SOL. In fact, the edge region inside the LCFS is only a short distance from the LCFS and the SOL. So changing conditions in the plasma edge will inevitably lead to similar changes in the LCFS and the SOL. And the reverse is also true: increasing the temperature and lowering the density in the SOL will create the same effects in the plasma edge.

Within the prior art, means have been described by which the LCFS plasma temperature is increased, and the density is decreased. These are often called “low recycling regimes”. The term low recycling regime applies specifically to the SOL, but this also affects the plasma edge inside the MC plasma, as described in the paragraph above. Low recycling regimes are almost always proposed as a means to improve energy confinement. Rarely, it has been mentioned that low recycling regimes, in tokamaks, can improve current drive efficiency at the edge (See “Low-recycling conditions and improved core confinement in steady-state operation scenarios in JET (Joint European Torus)”, R Cesario et al 2013 Plasma Phys. Control. Fusion 55 045005.).

However, a practical means of doing this to improve CD efficiency has not been described before now. For this purpose, “low recycling” is equivalent to a plasma edge with low density and high temperature, since low recycling leads to this. These are the conditions that improve CD efficiency. So, we will use the terms high temperature and low density instead of low recycling.

Several major and potentially disqualifying problems in the prior art arise when the temperature of the boundary of the MC region is high and the edge density is low. Since the field lines in the SOL intersect a wall, these problems arise, ultimately, from the interactions of the plasma with the wall with which it must eventually come into contact. These are particularly severe under conditions where fusion energy gain is possible.

Since the SOL is in contact with the relatively cold wall, it is difficult to raise the SOL temperature. But there is one way to have a high temperature in the SOL—by greatly lowering the density of the SOL. In its journey through the SOL, heat will be carried to the wall by very few particles and consequently, each particle must carry a lot of energy. This is the same as saying that the temperature of the SOL is high.

The present invention is a way to, simultaneously, create a boundary that is high-temperature and low-density, while overcoming plasma-wall interaction problems that arise in this situation. Consequently, this invention enables current to be driven more efficiently in the edge of a plasma.

Before describing potentially disqualifying problems that arise from a high-temperature, low-density SOL, we will comment on differences among possible embodiments of this invention, as they pertain to different circumstances in the prior art.

It is also important to distinguish two different classes of device with MC plasmas, both in the commercial sector and in the government sector. Some of the issues above apply more strongly to one type than to another. The first type of device has a high duty cycle, that is, they operate for a substantial fraction of the time. Devices to produce useful energy gain or neutron production are of this type. The second type of device has low duty cycle. These can operate with pulses in the range of seconds or minutes, followed by long periods with no operation. Devices with low duty cycle are usually research devices that are prototypes to develop devices of the first type. One example of a device with short duty cycle is SPARC, built by the private company Commonwealth Fusion Systems at a cost of roughly $1.5 billion. Another example is ST40, which is currently operated by the company Tokamak Energy Ltd. And yet another example ITER is a research device built according to an international agreement among governments, and it is on the borderline between long pulse and short pulse devices.

The present invention could apply to short pule devices like the ones above. Much longer pulse devices can also employ this invention, however some additional aspects must be added for such long pulses.

There is a somewhat related invention to this one, described in a provisional patent application by the one of the present authors, M. Kotschenreuther, entitled “Increasing energy gain in magnetically confined plasmas by increasing the EDGE temperature: the Super-XT divertor”, and filed on Jan. 28, 2023. That disclosure considers a divertor for the objective of increasing energy confinement. Both short pulse and long pulse problems for high-temperature low-density SOL are described in the Kotschenreuther Jan. 28, 2023 patent. That patent did not include improving CD efficiency as an objective of the invention, rather, the only objective referred to in Kotschenreuther Jan. 28, 2023 was to increase confinement. The application of that patent could also improve current drive in the edge, for both long pulses and short pulses. However, not all aspects of that invention are pertinent to the goal of increasing CD efficiency in the edge, especially for short pulse. Hence, both the objective of that invention, and various aspects of that invention differ from the invention in this disclosure.

We now turn to three serious problems that arise when a high-temperature, low-density SOL plasma interacts with the divertor target:
1) the high-energy particles in the SOL would knock off atoms of its surface, unacceptably eroding it. This eroded material would introduce impurities in the plasma which travel to the edge region. These impurities would reduce the CD efficiency.
2) The plasma species must be pumped very effectively to achieve a low-density SOL. As mentioned above, with a low density, a high SOL temperature will follow.
3) the heat flux cannot be allowed to melt the wall where the SOL strikes it.

These problems must be solved to arrive at a practical means of increasing the edge CD efficiency.

We now describe these problems in more detail. Atoms of the wall will be knocked out by a high-temperature SOL plasma, because those atoms are bound to materials with an energy on the order of eV. But is a high temperature SOL to improve CD efficiency, the SOL particles have about two orders of magnitude more energy than this binding energy. For example, the temperature of a high temperature SOL contemplated in this invention is 200 eV or more. Many plasma particles that strike the wall will have energies in the range of a thousand eV. When these plasma particles collide with the atoms of the wall, they transfer much more energy to them than their binding energy, so they are ejected from the surface. So, collisions of SOL particles with the wall result in a well-known process of “sputtering”: knocking some of its atoms out of the surface.

Many of these sputtered atoms will be ionized in the SOL and travel along field lines to the MC plasma, where many will be absorbed in the MC plasma.

This is the main route by which impurities reach the MC plasma region. There are other routes as well, however, for a short pulse device, these other routes may not supply enough impurities to the plasma to be disqualifying.

The effects of impurities on the current conduction of the plasma are described by a parameter known in the art as the effective Z, often dented by denoted by Z_{eff}. It is known in the art that the difficulty in driving current in an MC plasma is roughly inversely proportional to Z_{eff}. The effective Z for a region is defined as the ratio where the numerator is the sum of Nₛ Zₛ², where Nₛ is the number of ions of species s in the MC plasma region, and Zₛ is the charge state of each plasma species s (that is the number of electrons lost from the atom), and the denominator is the sum of the number of electrons Ne in the region.

Hence, impurities decrease the current drive efficiency.

By far, the most common resolution of these issues in the previous art is to stay away from an SOL that has high temperature and low density because the pertinent issues are regarded as too daunting to solve. In fact, ITER chooses an opposite operation scenario-create an SOL with as low a temperature, and as high a density as is practical. This leads to a low current drive efficiency at the edge.

Finally, we specifically consider the situation regarding toroidal pinches. As described before, both experiments and theoretical analysis showed that application of edge current drive produced order of magnitude improvements in energy confinement time, to values comparable to or greater than tokamaks. However, the community has not previously recognized that this highly-favorable result could be enhanced by using an edge with a high temperature and low density. We note that previous applications of lithium to implement low recycling to pinches failed to improve energy confinement (“The Reverse Field Pinch”, Marrelli et. al. 2021 Nucl. Fusion 61 023001, pg. 51). This is primarily because edge CD was not included to stabilize the MHD tearing instabilities. Furthermore, although a poloidal divertor was applied to toroidal pinch long ago, in 1995 (“A magnetic limiter study of a reversed field pinch plasma in TPE-2M”, Sato et. al., J. Nucl. Mater., 220-222 (1995) 693) this has never been repeated in the decades since. Thus, the importance, in a toroidal pinch, of a poloidal divertor together with a low recycling conditions, together with edge CD to achieve a high edge T and low edge n, has not been appreciated before this invention.

The present invention is a means to greatly increase the efficiency with which current can be driven in the edge of a plasma. Hence, more plasma can be stored in the magnetic configuration, and higher energy gain becomes possible. The invention does this by modifying the edge plasma conditions to be hotter, and less dense, so that current drive is much more efficient there.

Previous methods attempted to modify the interaction of the current driver with the plasma, without modifying the plasma. The present invention modifies the plasma.

The invention avoids these problems:
1) Impurities generated at the target, for example by sputtering, tend to travel along magnetic field lines and be absorbed in the MC plasma. This must be prevented since such impurities would reduce the CD efficiency.
2) The plasma species must be pumped very effectively to achieve a low-density SOL. As mentioned above, with a low density, a high SOL temperature will follow.
3) the heat flux cannot be allowed to damage the wall where the SOL strikes it. Also, the problem of unacceptable erosion of the target is solved.

An important aspect is to have a poloidal magnetic divertor, and a source of current drive.

Another important aspect of the invention features a divertor target that is placed in a region where the total magnetic field strength is substantially different from the value at the X point. This is accomplished by using external current means to generate magnetic fields, together with the magnetic fields from the plasma current, and positioning the divertor target appropriately within those fields. This has the effect of causing the creation of an electrostatic potential along field lines that shields the MC plasma from impurities generated in the divertor region by sputtering. In other words, it substantially prevents such impurities from getting into the MC plasma. Impurities in the MC plasma degrade the CD efficiency.

Note that most poloidal magnetic divertors have a magnetic field strength where the magnetic field strength at the X-point is nearly the same as the value at the target. Hence, they do not have the important impurity shielding effect.

In some embodiments, another aspect of the invention is that the divertor target facing the SOL is covered by liquids, that include, but are not limited to, molten metals such as lithium, gallium, or indium, and alloys containing them. These may pump the hydrogenic species out of the divertor region, to achieve an SOL with low density and high temperature.

In further embodiments, the divertor region can have a pumping means that is resistant to neutron radiation to achieve an SOL with low density and high temperature.

In yet other embodiments, the divertor target can be covered by liquid metal alloys to assist in resisting extremely high heat flux.

In further embodiments, density of the MC plasma at the LCFS is much less than the line average density of the MC plasma. We describe this in terms of quantities that are easiest to measure, as a ratio of the electron density on the last close closed flux surface to the line averaged electron density of the MC plasma of 0.2 or less.

In some embodiments, the rotational transform is greater than one over a substantial majority of the magnetically confined region.

In some embodiments, material in the divertor region absorbs deuterium, tritium, and hydrogen.

In some embodiments, a neutron resistant pumping means is operative to remove deuterium, tritium, and hydrogen. In some embodiments, the pumping means is located at the end of a duct that starts in the divertor region.

In some embodiments, a divertor target surface comprises a material that is liquid over at least some of the divertor target surface at least some of the time.

In some embodiments, an electron temperature is above 250 eV at a boundary of the magnetically confined region, and a ratio of the plasma electron density at the last closed flux surface to the line averaged electron density for a chord passing near the center of the magnetically confined plasma is less than 0.2.

In some embodiments, an electron temperature is above 500 eV at a boundary of the magnetically confined region, and a ratio of the plasma electron density at the last closed flux surface to the line averaged electron density for a chord passing near the center of the magnetically confined plasma is less than 0.15.

In some embodiments, an electron temperature is above 1000 eV at a boundary of the magnetically confined region, and a ratio of the plasma electron density at the last closed flux surface to the line averaged electron density for a chord passing near the center of the magnetically confined plasma is less than 0.1.

In some embodiments, the total magnetic field strength (comprising all components of the magnetic field) at the divertor target differs from the total magnetic field strength (comprising all components of the magnetic field) at a position of the X-point on a last closed flux surface nearest to it by over 20 percent.

In some embodiments, a divertor target surface comprises a material that is liquid over at least some of the divertor target surface at least some of the time.

### BRIEF DESCRIPTION OF THE DRAWINGS

FIG. 1 shows a cross-sectional view in the poloidal plane of a typical prior art embodiment.

FIG. 2 shows a cross-sectional view in the poloidal plane of the rotational transform.

FIG. 3 shows a cross-sectional view in the poloidal plane in one embodiment of the invention.

FIG. 4 shows a cross-sectional view in the poloidal plane in another embodiment.

### DETAILED DESCRIPTION

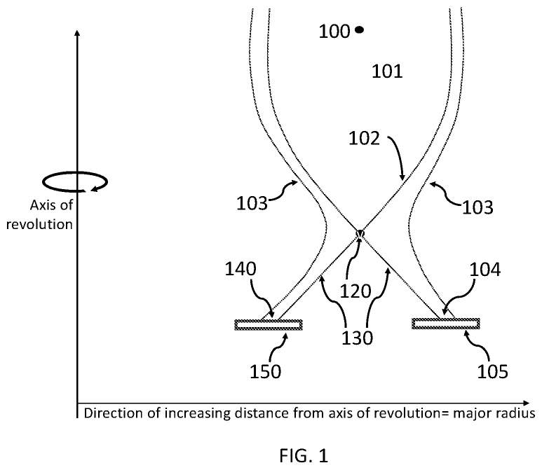

FIG. 1 gives one embodiment of the invention and also gives a graphical example of the terminology used in the descriptions. This terminology is standard within the art. The surfaces that are tangential to the magnetic field are flux surfaces. The plasma particles travel mainly within these surfaces and move relatively slowly across them. The geometry is approximately a torus, and so, there is an approximate axis of revolution. The distance of a point from this axis is referred to as the major radius of the point. A plane such as is shown in FIG. 1, in which the axis of revolution lies, is referred to as a poloidal plane. The magnetic field component that lies in this plane is called the poloidal magnetic field. The Last Closed Flux Surface (LCFS) 102 has one or more X-points 120 on it where the poloidal magnetic field vanishes. It is well known in the art that the flux surfaces at an X-point form an “X”, as shown. The region inside of the LCFS 101 is the Magnetically Confined plasma, or MC plasma, which has a magnetic axis 100. It is also well known in the art that a high-temperature SOL plasma has most of the heat and particles substantially bounded between two flux surfaces, one being the extension of the LCFS 130, called the separatrix within the art, and the other being the bounding SOL surface 103.

The SOL plasma strikes a material surface at the strike point 104 and 140, and the material surface is called the divertor target 105 and 150, which is also shown. Each X-point has two divertor targets associated with it, one of which is further from the axis of rotation 105, called the outboard divertor target, and the other is referred to as the inboard divertor target 150.

Shown in FIG. 1 is an embodiment where the X-point is at the bottom of the MC plasma; this configuration is called, in the art, a “lower null”. Another embodiment where the divertor is near an X-point at the top of the plasma is called an “upper null” and is just the reflection of FIG. 1 upward around the magnetic axis 100 so that the X-point is at the top of the MC plasma. Other embodiments have both an “lower null” and an “upper null”, that is, an X-point at both the top and the bottom. Still other embodiments can have an X-point located to the side rather than on the top or bottom.

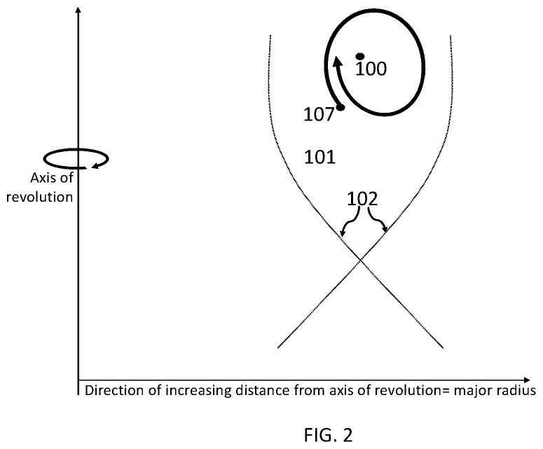

FIG. 2 shows the concept of the rotational transform, which defines a toroidal pinch. If one starts at a position on a poloidal plane in the MC region 101 inside the LCFS 102, at a starting point 107, and follows a field line for one rotation around the axis of revolution, the field line will rotate around the magnetic axis 100. If it rotates around the magnetic axis more than one full rotation, as shown in FIG. 2, the configuration is a toroidal pinch.

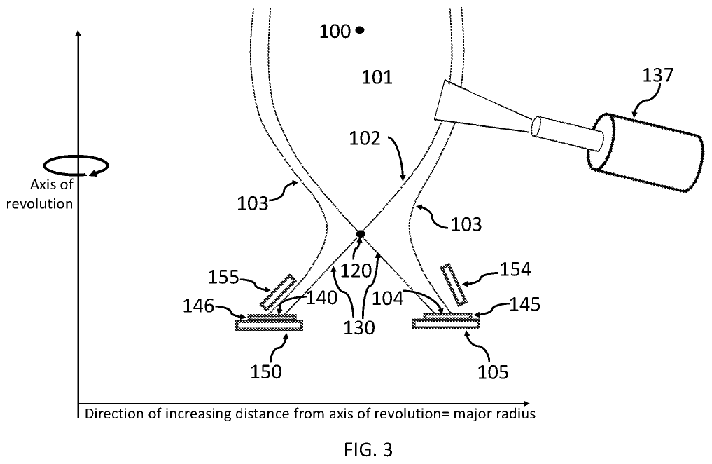

FIG. 3 is a representative embodiment of the invention showing the MC plasma 101, which has a magnetic axis 100, the LCFS 102, the lower X-point 120, the bounding surface of most of the SOL 103, the strike points 104 and 140 and the divertor targets 105 and 150. There is a current drive means 137 which acts to drive current in the edge region of the MC plasma 101, including substantially near the LCFS 102. In the divertor region, pumping means 154 and 155 are shown, which can be liquid metals, or a neutron resistant pumping means. One or more of the divertor targets have a liquid metal at the strike point 145 and 146.

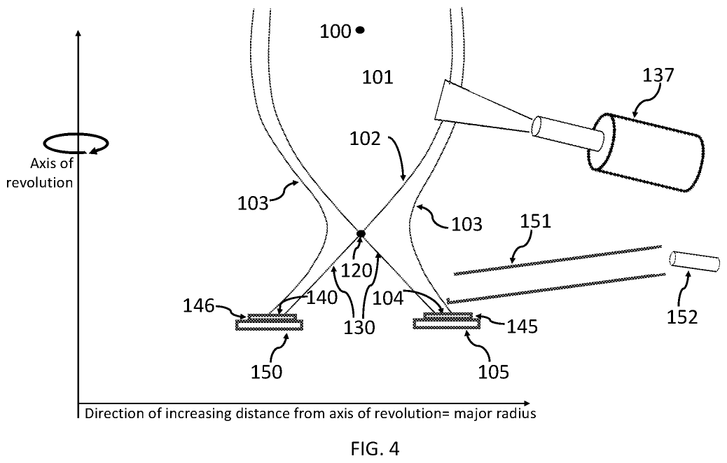

FIG. 4 is a representative embodiment of the invention showing the MC plasma 101, which has a magnetic axis 100, the LCFS 102, the lower X-point 120, the bounding surface of most of the SOL 103, the strike points 104 and 140 and the divertor targets 105 and 150. There is a current drive means 137 which acts to drive current in the edge region of the MC plasma 101, including substantially near the LCFS 102. A pumping duct 151 which starts in the divertor region and has pumping means at the end 152 in a region with much lower neutron flux is shown. One or more of the divertor targets have a liquid metal at the strike point 145 and 146.

Some embodiments of the invention are for magnetic geometries that are a lower single null. Other embodiments are for magnetic geometries with an upper single null. Yet other embodiments of this invention employ a double null geometry. Yet other embodiments have an X-point located to the side.

There are several key insights that motivate the invention. Firstly, the goal is to increase current drive efficiency by having a higher temperature, lower density plasma near the edge. This will lead to a higher temperature, lower density SOL. Major problems with this are overcome in this invention:
1) Impurities generated at the target, for example by sputtering, tend to travel along magnetic field lines and be absorbed in the MC plasma. This must be prevented since such impurities would reduce the CD efficiency.
2) The plasma species must be pumped very effectively to achieve a low-density SOL. As mentioned above, with a low density, a high SOL temperature will follow.
3) the heat flux cannot be allowed to damage the wall where the SOL strikes it, nor can there be unacceptable erosion.

To overcome the problem with impurities, a key physical dynamic arises, that aspects of the invention will cause to operate to advantage, are described below. This motivates the aspect of the invention where the magnetic field strength at the divertor targets is significantly different from that at the X-point on the LCFS.

The impurities for which this desirable dynamic applies include impurities generated by sputtering, by evaporation, and by recycling, and including, but not limited to, elements of the materials that face the plasma.

Analysis shows that by placing the divertor target in a region of either lower or higher magnetic field strength B, a strong electrostatic potential arises that has the effect of preventing impurities generated at the divertor target from reaching the MC plasma. The electrostatic potential, in effect, shields the MC plasma from the damaging impurities that are generated near the divertor target. These impurities would otherwise become ionized and travel along magnetic field lines to reach the MC plasma. This dynamic has not been used to advantage in the art, to the authors knowledge, until the recent patent by one of the present inventors, M. Kotschenreuther, entitled “Increasing energy gain in magnetically confined plasmas by increasing the EDGE temperature: the Super-XT divertor.”

This dynamic only occurs in an SOL with high-temperature and low-density, which is the regime of interest in this invention. Specifically, this electrostatic potential is strong when the mean free path for Coulomb collisions is longer than the characteristic distance traveled by a particle going along a magnetic field line from the divertor target to the MC plasma. Such a long mean free path arises in an SOL with high-temperature and low density. This electrostatic potential is far weaker in the conventional operating regime of a divertor, which has low temperature and high density.

The following explains how this is done. In the low collisionality regime of interest to this invention, consider the case where the divertor target has a magnetic field strength less than the X-point. The magnitude of the potential difference along a magnetic field line is very roughly of a magnitude˜(Tₑ/e) ln(Bₓ/B_{target}), where Tₑ is the electron SOL temperature, e is the charge on the electron, Bₓ is the total magnetic field strength at the X-point and B₂ is the total magnetic field strength at the divertor target, and ln is the natural logarithm.

Consider the case where the divertor target has a magnetic field strength less than the X-point. The analysis is considerably more complicated because of so-called trapped particles, that is, particles trapped in magnetic wells by mirror forces. However, a potential nonetheless arises that is of magnitude (Tₑ/e) and increases in size as the ratio B_{target}/Bₓ increases, but vanishes when B_{target}=Bₓ.

A potential with the magnitude of Tₑ will have a very large impact on the path of an impurity in this regime. Impurities in the SOL plasma are generated by sputtering or evaporation or recycling, and in all these cases the energy of the impurity is in the range of several eV or less. This invention applies to SOL where Tₑ is about 200 eV or more, which is far greater than the energy of the impurities. In this case, the potential can prevent impurities from reaching the MC plasma. Impurities are positively charged, so the sign of the electrostatic potential will be too large of a potential hill for them to climb.

Also, if the Coulomb collisional mean free path is long, the electrostatic potential reflects impurities back to the divertor on a time scale much shorter than the time for the impurity to be heated by the SOL plasma to a high enough energy so that the impurity can overcome the electrostatic potential.

To summarize the preceding few paragraphs: in the regime of density and temperature for this embodiment of the invention, the MC plasma is insulated from impurities generated in the SOL at the divertor target, if the target is in a region where the total magnetic field strength is significantly different from the magnetic field strength at the X-point. This is of great importance to avoid contamination of the MC plasma by impurities, since impurities reduce the current drive efficiency.

Hence, an aspect of the invention is that the magnetic field strength at the divertor target is substantially different from the magnetic field strength at the X-point.

The present invention employs a novel configuration of magnetic fields. For most poloidal divertor configurations, there is very little difference between the magnetic field strength at the X-point and the target. There are several reasons for this. One is that these two points are usually fairly close in space, so the field strength simply does not change much between these positions. The other is that many divertor targets are located roughly vertically underneath (or on top of) the corresponding X-point. The magnetic field strength in tokamaks is well known to vary little in the vertical direction.

In order to create the circumstance where the magnetic field strength at the target is substantially different from the corresponding X-point, magnetic field generating means in the region outside the LCFS are used, and the position of the targets must be suitably chosen.

Let us now consider the second problem mentioned at the beginning of this section: The plasma species must be pumped very effectively to achieve a low-density SOL. And with a low density, a high SOL temperature will follow.

This pumping must be achieved by means that are resistant to the strong neutron radiation that is present in a device with copious fusion reactions.

One means for this is to use a material that chemically binds to hydrogen that is recycled from the walls. Examples of such material include, but are not limited to, lithium, alloys containing lithium, and titanium. These materials can be in solid or liquid form.

Pumping methods that are resistant to neutrons are disclosed in the provisional patent application by inventor M. Kotschenreuther entitled “Vapor Diffusion Pump for low recycling divertor”, filed on Jun. 26, 2023. Other embodiments could use other methods.

Another method is to have a pumping means located at the end of a duct, where one end of the duct starts in the divertor region, and a pumping means is at the other end of the duct, so that the pump is not located in the region of high neutron radiation.

An example of a pumping method that is not resistant to neutrons is a cryopump. Cryopumps are often used in the art for configurations that are not exposed to large fluxes of neutrons. This type of pump operates at a temperature of several degrees kelvin. This low temperature is incompatible with the intense heating from very penetrating neutrons in the vicinity of a fusion plasma.

Finally, we turn to the third problem mentioned in the beginning of this section: the heat flux should be allowed to damage the wall where the SOL strikes it.

For this application, it can be beneficial to have the divertor target coated with a thin layer of liquid metal. By doing this, erosion at the divertor problem can also be solved by replenishing the liquid. This can be beneficial for removing heat. In some embodiments, this could use the methods disclosed in provisional patent applications by M. Kotschenreuther: “Oscillatory mag heat dispersal” filed on Jun. 26, 2023, or “Divertor with Microchannel Heat Sink and Liquid Metal Plasma Facing Material” filed on Jun. 26, 2023, both of which are incorporated herein in their entireties by reference. Other embodiments could use both of these methods, or other methods. In some embodiments the liquid metal can be one where the sputtering is primarily of low Z material, as in the provisional patent by M. Kotschenreuther titled “Liquid metal compositions for use as plasma facing components” and filed on Nov. 19, 2022, which is incorporated herein in its entirety by reference. In other embodiments another liquid metal could be used.

1. A toroidally confined plasma vessel comprising:
a toroidal plasma chamber;
a magnetically confined (MC) plasma region where particles traveling along magnetic fields substantially never strike a wall;
where the magnetically confined plasma region is substantially symmetric by rotation around a central axis;
a plurality of magnetic field coils; and
a divertor assembly with a divertor target;
wherein a plurality of magnetic field coils is configured to provide at least one X-point, and to guide plasma particles from the magnetically confined plasma region to the divertor target;
wherein a total magnetic field strength (comprising all components of the magnetic field) at the divertor target differs substantially from a total magnetic field strength (comprising all components of the magnetic field) at a position of the X-point on a last closed flux surface nearest to it; and
wherein a current drive means is operative in the MC plasma, including in the region near the Last Closed Flux Surface.

2. The toroidally confined plasma vessel of claim 1, wherein the rotational transform is greater than one over a substantial majority of the magnetically confined region.

3. The toroidally confined plasma vessel of claim 1, wherein material in the divertor region absorbs deuterium, tritium, and hydrogen.

4. The toroidally confined plasma vessel of claim 1, wherein a neutron resistant pumping means is operative to remove deuterium, tritium, and hydrogen.

5. The toroidally confined plasma vessel of claim 4, wherein the pumping means is located at the end of a duct that starts in the divertor region.

6. The toroidally confined plasma vessel of claim 1, wherein a divertor target surface comprises a material that is liquid over at least some of the divertor target surface at least some of the time.

7. The toroidally confined plasma vessel of claim 1, wherein an electron temperature is above 250 eV at a boundary of the magnetically confined region, and a ratio of the plasma electron density at the last closed flux surface to the line averaged electron density for a chord passing near the center of the magnetically confined plasma is less than 0.2.

8. The toroidally confined plasma vessel of claim 1, wherein an electron temperature is above 500 eV at a boundary of the magnetically confined region, and a ratio of the plasma electron density at the last closed flux surface to the line averaged electron density for a chord passing near the center of the magnetically confined plasma is less than 0.15.

9. The toroidally confined plasma vessel of claim 1, wherein an electron temperature is above 1000 eV at a boundary of the magnetically confined region, and a ratio of the plasma electron density at the last closed flux surface to the line averaged electron density for a chord passing near the center of the magnetically confined plasma is less than 0.1.

10. The toroidally confined plasma vessel of claim 1, wherein the total magnetic field strength (comprising all components of the magnetic field) at the divertor target differs from the total magnetic field strength (comprising all components of the magnetic field) at a position of the X-point on a last closed flux surface nearest to it by over 20 percent.

11. The toroidally confined plasma vessel of claim 2, wherein material in the divertor region absorbs deuterium, tritium, and hydrogen.

12. The toroidally confined plasma vessel of claim 2, wherein a neutron resistant pumping means is operative to remove deuterium, tritium, and hydrogen.

13. The toroidally confined plasma vessel of claim 12, wherein the pumping means is located at the end of a duct that starts in the divertor region.

14. The toroidally confined plasma vessel of claim 2, wherein a divertor target surface comprises a material that is liquid over at least some of the divertor target surface at least some of the time.

15. The toroidally confined plasma vessel of claim 2, wherein an electron temperature is above 250 eV at a boundary of the magnetically confined region, and a ratio of the plasma electron density at the last closed flux surface to the line averaged electron density for a chord passing near the center of the magnetically confined plasma is less than 0.2.

16. The toroidally confined plasma vessel of claim 2, wherein an electron temperature is above 500 eV at a boundary of the magnetically confined region, and a ratio of the plasma electron density at the last closed flux surface to the line averaged electron density for a chord passing near the center of the magnetically confined plasma is less than 0.15.

17. The toroidally confined plasma vessel of claim 2, wherein an electron temperature is above 1000 eV at a boundary of the magnetically confined region, and a ratio of the plasma electron density at the last closed flux surface to the line averaged electron density for a chord passing near the center of the magnetically confined plasma is less than 0.1.

18. The toroidally confined plasma vessel of claim 2, wherein the total magnetic field strength (comprising all components of the magnetic field) at the divertor target differs from the total magnetic field strength (comprising all components of the magnetic field) at a position of the X-point on a last closed flux surface nearest to it by over 20 percent.

19. The toroidally confined plasma vessel of claim 1, wherein the total magnetic field strength (comprising all components of the magnetic field) at the divertor target differs from the total magnetic field strength (comprising all components of the magnetic field) at a position of the X-point on a last closed flux surface nearest to it by over 40 percent.

20. The toroidally confined plasma vessel of claim 2, wherein the total magnetic field strength (comprising all components of the magnetic field) at the divertor target differs from the total magnetic field strength (comprising all components of the magnetic field) at a position of the X-point on a last closed flux surface nearest to it by over 40 percent.
